(19) United States
(12) Patent Application Publication
(10) Pub. No.: US 2002/0162193 A1
(43) Pub. Date: Nov. 7, 2002

(54) Adjustable door hinge monitoring device

(76) Inventor: Thomas J. Frys, New York, NY (US)

Correspondence Address: Mr. Hummer, P.O. Box 608, Gates Mills, OH, 44040, US

(21) Appl. No.: 09/845,972

(22) Filed: May 1, 2001

(51) Int. Cl. E05D 5/02

(52) U.S. Cl. 16/387

(57) ABSTRACT

The invention is in a device for monitoring the position of a swinging door that is mounted on a stationary frame, the device essentially comprises a magnet and magnetic proximity sensor which are mounted in coaxially aligned relation on a pair of opposing leafs of a hinge. Means are provided for moving the magnet to and from the sensor to correspondingly vary the gap or spacing between them.

### BACKGROUND OF THE INVENTION

The invention relates to hinges, especially piano type hinges which are used to mount a swinging door to a fixed door frame. Such doors may be made of any suitable material, such as wood, plastic, or metal, and the hinges may be made of any appropriate material, including plastic or metal, such as aluminum, steel or brass.

More particularly, the invention is in a magnetic device for monitoring the opening and closing of a door as it swings to and from a closed position in a fixed door frame to which the door is mounted.

### DESCRIPTION OF THE DRAWINGS

The following description of the invention will be better understood by having reference to the accompanying drawing, wherein:

FIG. 1 is a partial sectional view which is designed to show a prior art door monitoring device;

FIG. 2 is a perspective view of a piano hinge and door monitoring device which is made in accordance with the invention; and

FIG. 3 is a cross sectional view which is designed to show the door monitoring device of the invention in greater detail, when it is mounted on the leafs of a door hinge.

### DETAILED DESCRIPTION OF THE DRAWING

With general reference to the drawing for like parts and particular reference to FIG. 1, there is shown a prior art door monitoring device 5 which essentially comprises conventional components of, 1) a cylindrical magnetic proximity sensor 6 which is secured by any suitable adhesive to a hinge leaf 7 which is fastened by screws to an adjacent, fixed door frame 8, and 2) a cylindrical neodymium iron boron magnet 9 which is, likewise, secured by an adhesive to the opposing hinge leaf 10 which is fastened by screws to a door 11 which, in turn, is mounted for swinging relation on the fixed door frame 8 by the fixed and rotary leafs 7 and 10 of a hinge 12.

It is well known by those skilled in the art, that the north pole 13 of the magnet 9 should be placed in abutting relation with the rotary hinge leaf 10 and in confronting relation with the south pole 14 of the sensor 6 which is in abutting relation with the opposing stationary hinge leaf 7. Moreover, for optimum operation of the DM (door monitoring) device 5, there should be a predetermined gap between the magnetic fields of the sensor 6 and magnet 9, such gap being more easily viewed and measured as the corresponding gap or spacing between the north and south poles 13 and 14 of the magnet 9 and sensor 6. This is accomplished in the prior art by securing the sensor 6 and magnet 9 in predetermined axially offset relation on the fixed and rotary hinges 7 and 11, where the sensor 6 and magnet 9 extend into adjacent openings 15 and 16, respectively, in the door frame 8 and door 11, as best seen when the hinge 12 is in a closed position where the hinge leafs 7 and 10 are adjacently disposed in abutting or closest spaced relation as shown in FIG. 1. The sensor 6 has a pair of electrical lead wires 17 and 18 which are electrically connected to a pair of similar wires 19 and 20 for carrying low voltage electric current from the sensor 6 to a remotely located signaling device 21, such as a buzzer, bell, or ligh which, for example, can be used in conjunction.with a centralized security system.

Unfortunately, the sensor 6 or magnet 9 of prior art DM devices 5 are occasionally, accidentally knocked off during transportation or installation of the DM devices 5, thereby necessitating the replacement of the component with a new one in exactly the same spot, which is not always easy to do in the field. The invention overcomes this problem by the provision of an improved DM device 5 wherein, 1) the sensor 6 and magnet 9 are firmly secured in axially aligned relation to the leafs 7 and 10 of the hinge 12, so that they can not be accidentally knocked off from the hinge 12, and 2) the gap between the sensor 6 and magnet 9 is easily adjusted.

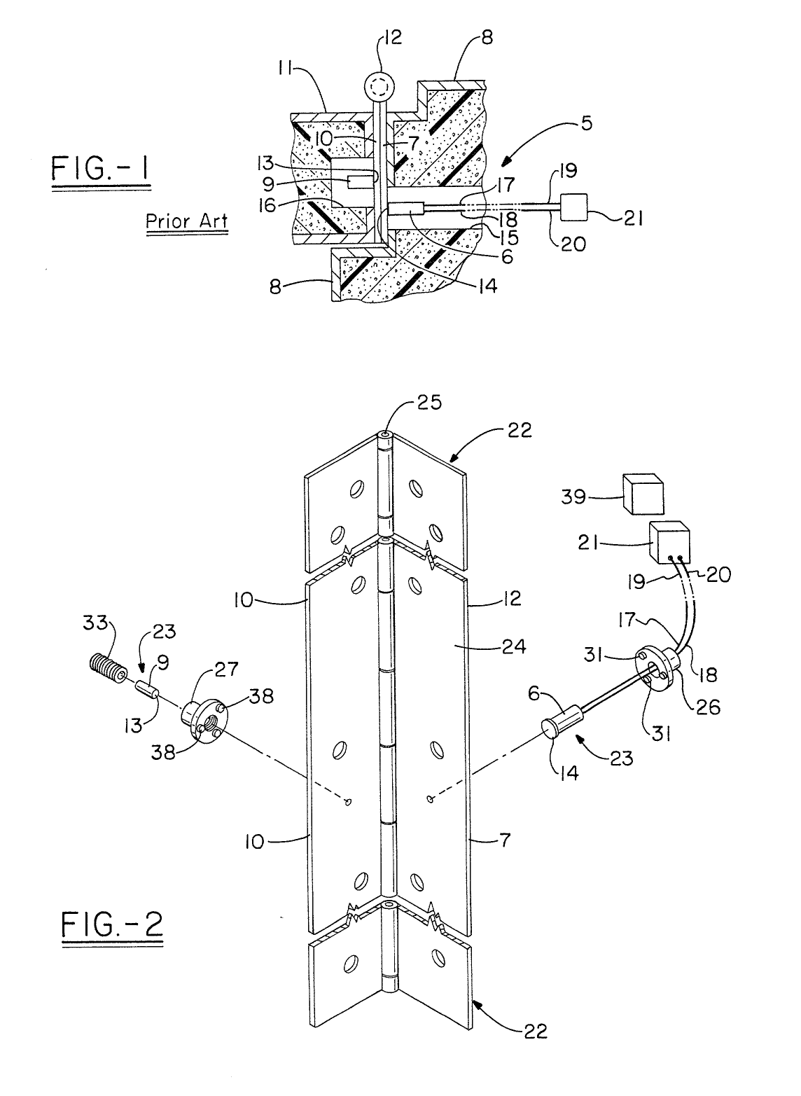

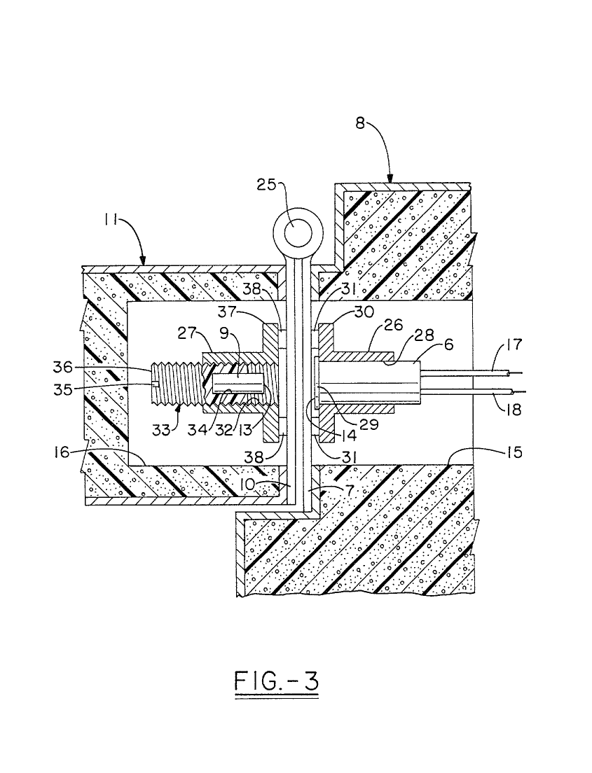

With reference to FIGS. 2 and 3, there is shown a metal piano-type hinge 22 which is substantially coextensive with the height of the door 11, when the door 11 is mounted on the fixed door frame 8. The hinge 12 to which the new improved DM device 23 of the invention is operatively connected, is an independent metal section 24 of the piano hinge 23, which section 24 is about 12 inches, in length, and is disposed centrally between the opposing ends of the piano-hinge 22, and includes a metal hinge pin 25 that is common to the piano hinge 22. In instances where three hinges are used to mount the door 11, the DM device 23 is operatively connected to the middle hinge.

The new DM device 23 comprises a pair of stainless steel members, e.g. rigid weld nuts 26 and 27 which are disposed on the hinge leafs 7 and 10, respectively, in opposed confronting relation, when the door 11 is closed and the hinge leafs 7 and 10 are in closest spaced relation, as best seen in FIG. 3.

The first weld nut 26 is mounted in outstanding relation on the fixed hinge leaf 7 that is secured to the door frame 8, and has a smooth, cylindrical center bore 28 which has a longitudinal axis that is normal to the plane of the fixed hinge leaf 7. The sensor 6, in this instance, is provided with an outstanding annular stop 29 which engages the first weld nut 26 when the sensor 6 is properly press-fitted in the smooth bore 28 where the longitudinal axis of the sensor 6 is also normal to the plane of the stationary hinge leaf 7. The first weld nut 26 is provided with an outstanding annular flange 30 around which are equally, angularly spaced three, similar projections 31 which are welded to the stationary hinge leaf 7.

The second, stainless steel weld nut 27 is mounted in outstanding relation on the rotary hinge leaf 10 that is secured to the swinging door 11, and has an internally threaded, center bore 32 which has a longitudinal axis that is normal to the plane of the rotary hinge leaf 10. The threaded bore 32 is designed to threadably receive an externally threaded nylon rod 33 which has a centrally disposed, smooth cylindrical recess 34 in which the cylindrical magnet 9 is press-fitted and extends therefrom in the direction on the adjacent rotary hinge leaf 10 in axially aligned with the confronting sensor 6, when the door 11 is closed. The threaded rod 33 has a slot 35 at its opposing end 36 for receiving a tool for rotating the threaded rod 33 and attached magnet 9 into and out of the internally threaded bore 32 to adjust the size of the gap or spacing between the axially aligned sensor 6 and magnet 9. The second weld nut 27 has a similar, outstanding annular flange 37 around which are equally angularly spaced, three similar projections 38 which are welded to the rotary hinge leaf 10.

Thus, there has been described a unique device for monitoring the opening and closing of a swinging door that is mounted on a fixed door frame. The DM devices 23 can be used in conjunction with a number of television cameras and screens 39 to visually show an operator when doors are not properly closed and remain open or slightly ajar.

What is claimed is:

1. A door monitoring device, comprising:
a) a magnetic proximity sensor;
b) a first means for securing the sensor to a first leaf of a hinge having a pair of leafs;
c) a magnet;
d) a second means for securing the magnet to a second leaf of the hinge, such that the magnet and sensor are in confronting spaced relation, when the hinge is closed where the leafs of the hinges are in closest space relation; and
e) a third means for moving the magnet to and from the sensor to vary the gap between them.

2. The device of claim 1, wherein the sensor and magnet are each generally cylindrical and have longitudinal axes, and the sensor and magnet are in coaxial alignment.

3. The device of claim 2, wherein the third means includes moving the magnet axially to and from the sensor.

4. The device of claim 3, which includes:
f) an electrically responsive signaling device remote from the sensor; and
g) means for electrically connecting the sensor to the signaling device to carry low voltage electric current from the sensor to the signaling device.

5. The device of claim 3, wherein the first means includes;
h) a first rigid member having a longitudinal, smooth, cylindrical bore for receiving the sensor in compressive engagement.

6. The device of claim 4, wherein the second and third means include:
j) a second rigid member having an internally threaded bore having a longitudinal axis;
k) an externally threaded rod for threaded engagement in the threaded bore, the rod having a pair of opposing ends, the first of which ends has a cylindrical recess for compressively receiving the magnet and from which the magnet extends in the direction of the sensor; and
m) a configured slot at the second of the opposing ends of the rod for receiving a tool that is used to rotate the rod into and out of the internally threaded bore to vary the gap between the sensor and magnet.

7. The device of claim 6, wherein the first and second members are metal weld nuts which cab be welded to leafs of a metal hinge.

8. The device of claim 7, which includes a piano-type metal hinge, and the hinge leafs to which the sensor and magnet are secured, are metal leafs of an independent section of the piano hinge which has a hinge pin that is common to the section.

9. The device of claim 8, wherein each of the weld nuts has an outstanding annular flange around which are equally angularly spaced, a plurality of similar size projections for welding to adjacent metal hinge leafs.

10. The device of claim 9, wherein metals used in the device are metals from the group of aluminum, steel, stainless steel, brass and bronze.

11. A device for monitoring the opening and closing of a swinging door which is secured to a rotary, metal hinge leaf that is hinged to a stationary, metal hinge leaf which is designed to be secured to a fixed door frame, comprising:
a) a substantially cylindrical magnetic proximity sensor coaxially press-fitted into the smooth center bore of a first metal weld nut which has a plurality of similar metal projections equally angularly spaced around the center axis of the smooth bore, the projections extending from the first weld nut for welding to the stationary hinge leaf, the sensor having an annular stop which abuts the first weld nut, when the sensor is properly disposed in the smooth bore where the center axis thereof is normal to the plane of the stationary hinge leaf;
b) a cylindrical magnet press-fitted into a smooth cylindrical center recess of an externally threaded nylon rod and extending therefrom in the direction of a the rotary hinge leaf;
c) a second, rigid metal weld nut having an internally threaded center bore for threadably receiving the externally threaded rod, the center bore being coaxially aligned with the sensor and magnet when the hinge leafs are closed in closest spaced relation, the second weld nut also having a plurality of similar metal projections which are equally angularly spaced around the center axis of the threaded center bore, and which extend from the second weld nut for welding to the rotary hinge leaf;
d) means on the threaded rod for receiving a tool to rotate the rod and attached magnet into and out of the threaded bore to correspondingly vary the gap between the magnet and sensor; and
e) openings in the door and door frame for receiving the weld nuts.

12. The device of claim 11, which includes a metal, piano-type hinge which is coextensive with the door and used to mount the door on the door frame, the hinge leafs to which the weld nuts are secured are independent of the leafs of the piano hinge, but are hinged together by a hinge pin which is common to the piano hinge, the independent leafs being disposed between opposing ends of the piano hinge and being relatively short compared to correspondingly measured leafs of the piano hinge, the door and door frame each being provided an opening for receiving the weld nuts,

13. The device of claim 12, wherein each of the weld nuts includes an outstanding annular flange around which the projections are spaced, and from which the projections extend, and with which the projections are integrally formed.
